(19) United States
(12) Patent Application Publication
(10) Pub. No.: US 2026/0262630 A1
(43) Pub. Date: Sep. 10, 2026

(54) ENHANCED OPTICAL SYSTEM FOR REAL-TIME ENVIRONMENTAL AND WILDLIFE BIOMETRIC ASSESSMENT

(71) Applicants: Matthew Lopez, Dallas, TX (US); Jeffrey Ozanne, La Crosse, WI (US)

(72) Inventors: Matthew Lopez, Dallas, TX (US); Jeffrey Ozanne, La Crosse, WI (US)

(21) Appl. No.: 19/074,266

(22) Filed: Mar. 7, 2025

(51) Int. Cl. A01M 31/00; G06T 7/62; G06V 10/764; G06V 40/10; G06V 40/20

(52) U.S. Cl. CPC A01M 31/002; G06T 7/62; G06V 10/764; G06V 40/10; G06V 40/25

(57) ABSTRACT

An enhanced optical device includes a processor configured to receive captured data from one or more sensors and used the captured data to compare the captured data associated with one or more biological targets to at least one reference. The processor is further configured to determine characteristics of one or more of the biological target and an environment associated with the biological target based on the comparison. The enhanced optical device may use the determined characteristics to assist an operator in hunting the biological target. The enhanced optical device may perform automated scoring, environmental, and/or other analysis of data associated with a biological target or environment in real-time to assist an operator to hunt.

### FIELD OF THE INVENTION

This invention relates generally to hunting equipment, and specifically to improvements in hunting equipment configured to assess characteristics of one or more biological target(s) and/or an environment associated with a biological target(s) in real-time.

### BACKGROUND

The pursuit of hunting has long been an activity that requires precision, skill, and extensive knowledge of wildlife. In many regions, hunting regulations impose specific criteria that must be met before a target can be legally taken. These criteria may include age, size, and overall health of the animal. Traditional hunting equipment may include distance location from a laser-based range finder, location information from a GPS sensor or mapping data, and means for measuring wind speed in an environment local to a hunter (e.g., in an area physically occupied by the hunter).

In some examples, a hunter may score an animal for purposes of evaluating the difficulty/rarity of the animal and/or to ascertain whether harvesting the animal complies with local regulations. Some hunters use scoring criteria published by firms such as Pope & Young, and Boone & Crockett which specify criteria used to score various types (i.e., species) of target animals, and define a minimum score which should be met in order to meet various rules and/or regulations. These criteria may vary significantly across different species and/or sub-species of target animals. For example, different bear species may be scored based on a size of the bear's skull. An antlered/horned animal may be scored based on various measurements specific to the particular size and shape of various features of the animal's antlers/horns. A target animal may also, or instead, be scored to meet regulations or otherwise based on an age of the animal or another characteristic of the animal.

In some examples, it may significant experience to anecdotally score an animal and/or determine whether hunting that particular animal is in compliance with local rules and regulations. In some examples, a hunter with the experience to score a particular animal may need to carry additional equipment in order to perform the analysis required after the animal has been harvested. In some examples, hunters typically score an animal after the animal has been harvested. A hunter who mistakenly mis-scores an animal may risk punishment such as suspension of a hunting license, fines, confiscation of hunting equipment, or even imprisonment.

Using traditional hunting equipment, it may take years for one to obtain the necessary training to obtain the skills to perform the various tasks associated with a successfully hunt, including evaluating potential hunting terrain, predicting where animals may travel or congregate, deciding where a hunter should position themselves to avoid detection by potential biological target(s), and/or an impact of environmental factors such as wind, weather, season, temperature. The time and dedication needed to learn all these skills may serve as a barrier to those interested in the sport. In addition, whether skilled or not, a hunter must typically bring discrete equipment for the various tasks performed during a hunt, which may limit a hunter's mobility in the field

### SUMMARY

In some aspects, a device is described that includes a processor configured to receive captured data from one or more sensors and used the captured data to compare the captured data associated with a biological target to at least one reference. The processor is further configured to determine characteristics of the biological target and an environment associated with the biological target based on the comparison.

In some aspects, a method is described that includes identifying a biological target in the field of view of the one or more sensors. The method further includes comparing captured image data associated with the biological target to a reference. The method further includes determining characteristics of the biological target and an environment associated with the biological target based on the comparison.

In some aspects, a computer-readable medium is described that stores instructions configured to cause a computing device to identify a biological target in the field of view of the one or more sensors. The instructions further cause the computing device to compare the captured data associated with the biological target to a reference. The instructions further cause the computing device to determine characteristics of the biological target and/or an environment associated with the biological target based on the comparison.

### BRIEF DESCRIPTION OF THE DRAWINGS

FIG. 1 is a diagram that depicts an enhanced optical device configured to perform real-time assessment of one or more biological target(s) according to some embodiments.

FIG. 2 is a block diagram depicting an enhanced optical device according to some embodiments.

FIG. 3 is a block diagram showing some examples of image processing techniques that may be used to determine an estimation of a distance between the device and a biological target or other object according to some embodiments.

FIGS. 4A-4B, 5A-5B, and 6A-6B depict features of particular animals used for scoring according to the Boone & Crockett criteria according to some embodiments.

FIG. 7 is a diagram that shows some non-limiting examples of measurements that might be used to estimate an age of an animal applied to a white-tailed deer according to some embodiments.

FIG. 8 is a block diagram depicting non-limiting examples of techniques that may be used to determine at least one characteristic of wind or air to assist an operator to hunt according to some embodiments.

FIG. 9 is a diagram depicting a biological target, a deer, visible through the scope of long-distance viewing feature of a weapon, rangefinder or the like according to some embodiments.

FIG. 10 is a block diagram that depicts machine learning models that may be used to implement functions of an enhanced optical device according to some embodiments.

FIG. 11 is a flow diagram that depicts one example of a method of operating an enhanced optical device according to some embodiments.

### DETAILED DESCRIPTION

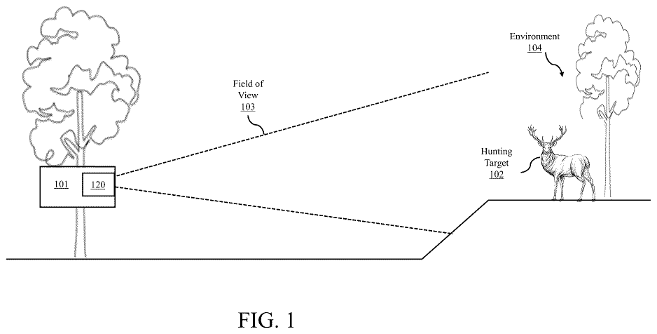

FIG. 1 is a diagram that depicts an enhanced optical device 101 configured to perform real-time assessment of one or more biological target(s) 102 according to some embodiments. As shown in FIG. 1, the enhanced optical device 101 includes one or more image sensor(s) 120 with a field of view 103. The image sensor(s) 120 are configured to capture image data within the field of view 103. In FIG. 1, one non-limiting example of a biological target 102, a deer, is in the field of view 103.

The enhanced optical device 101 depicted in FIG. 1 is uniquely configured to perform real time assessment of image data from the image sensor(s) 120 to assess biological target(s) 102 and/or an environment 104 within the field of view 103 of the image sensor(s) 120. The enhanced optical device 101 processes the image data, alone or along with data from other sources, to assist an operator to hunt the biological target(s) 102. For example, the enhanced optical device 101 may process the image and/or other data to compare one or more characteristics associated with the biological target(s) 102 and/or the environment 104 to a reference to determine characteristics of the biological target 102 and/or environment 104, and communicate those characteristics to an operator and/or otherwise use the determined characteristics to assist the operator to hunt. In some examples, the enhanced optical device 101 may operable to determine characteristics of an environment 104 located distal from the enhanced optical device 101 (e.g., in a position not physically occupied by the enhanced optical device 101 and/or operator) where biological target(s) 102 are or might be located in the future.

FIG. 1 shows an example in which the enhanced optical device 101 is a trail camera or similar device secured to a tree. According to such examples, the enhanced optical device 101 may be communicatively coupled to a network and configured to communicate with an operator remotely via another device coupled to the network. In other examples, the enhanced optical device 101 may be part of other equipment used in hunting such as a hunting weapon like the scope of a gun, crossbow, bow, blowgun or other weapon that might be used by a hunter. In other example, the enhanced optical device 101 may be used in a long-distance viewing device such as a telescope, a pair of binoculars, a spotting scope and/or a rangefinder and/or other viewing device such as a tablet computer, smartphone, wearable device such as a watch, smart glasses, or the like. In still other examples, the enhanced optical device 101 be part of a drone or other arial, ground, or water based robotic device configured to collect image data as described.

As mentioned above, the enhanced optical device 101 is operable to assist an operator to hunt one or more biological target(s) 102, and examples are provided herein applied to particular types of animals (e.g., species, sub-species or other grouping) that may be assessed as biological target(s) 102 to determine characteristics specific to those animals and use them to assist an operator. One of ordinary skill in the art will understand that the various functions of the enhanced optical device 101 described herein may be applied assist an operator to hunt any type of animal whether or not specifically mentioned. In addition, one of ordinary skill in the art will understand that the enhanced optical device 101 may be used for applications beyond hunting of non-human animals for sport or otherwise, and may be similarly used for military, police, biological research, commercial, or other purpose where assessment of biological target(s) 102 and/or associated environment(s) 104 may be useful.

The enhanced optical device 101 may assist an operator to harvest a biological target(s) 102, meaning to assist the operator to incapacitate and/or kill the biological target(s) 102. For example, the enhanced optical device 101 may assist a hunter to shoot the biological target(s) 102 with a lethal arrow, bullet or dart, or otherwise kill the animal with a knife, dart, axe, sword or the like. In other examples, the enhanced optical device 101 may assist an operator to otherwise incapacitate the biological target(s) 102 (e.g., with a medicated dart) to enable biological target(s) 102 to be safely netted, caged, or otherwise restrained.

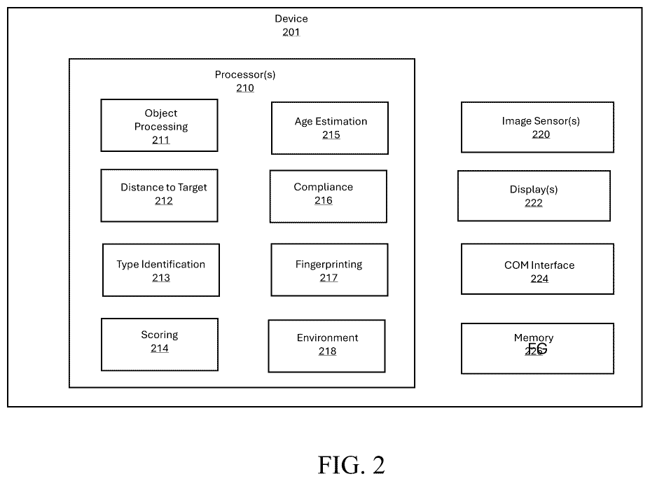

FIG. 2 is a block diagram depicting an enhanced optical device 201 according to some embodiments. As described above, the enhanced optical device 201 may be a trail camera installed on a tree as shown in the example of FIG. 1. In other examples not depicted in FIG. 1, the enhanced optical device 201 may be other equipment that may be used by an operator to hunt, such as the scope of a weapon, as part of a long-range viewing device, and/or part of a drone or other vehicular robot.

As shown in FIG. 2, the device 201 includes one or more processor(s) 210, one or more image sensor(s) 220, one or more communications interface(s) 224, and one or more memories 226. The image sensor(s) 220 may be a CMOS or other type of image capture sensor configured to detect image data within a field of view of the image sensor(s) 220, which may be operated with one or more of lenses, waveguides, apertures, mirrors, and the like configured to capture image data. In some examples, the image sensor(s) may be configured to capture image data representing reflected light of visible wavelengths. In other examples, the image sensor(s) 220 may also or instead capture image data representing reflection of other wavelengths of light, including infrared light. The enhanced optical device 201 may be configured such that the image sensor(s) 220 may be pointed in a particular direction to capture image data of a scene.

The image sensor(s) 220 may be coupled to analog to digital conversion (ADC) or other signal processing circuitry (not shown in FIG. 2) configured to prepare captured image data for use by the processor(s) 210. The communications interface(s) 224 may included dedicated circuitry and/or executable software configured to enable communications between the enhanced optical device 201 and other computing, sensor, server, or other devices. For example, the communications interface(s) 224 may be configured to support one or more of a cellular network, wi-fi network, or other wireless or wired network. As one specific example of a wi-fi network, communications interface(s) 224 may be configured to be coupled to a remotely accessible wi-fi network such as the Starlink network made available by SpaceX or other satellite-based network.

The processor(s) 210 may include one or more components of the device 201, or components communicatively coupled to the device 201 (e.g., a server or other device) via the communication interface 224 and configured to implement the various functions of the enhanced optical device 201, at least some of which are represented as various modules 211-219 in the FIG. 2 example. The processor(s) 210 may include any combination of computing components housed within device 201 as shown or housed elsewhere. In some examples, the processors may include traditional processors such as one or more of a central processing unit (CPU), microprocessor, microcontroller, Application Specific Integrated Circuit (ASIC), Field Programmable Gate Array (FPGA) or the like configured to execute rule-based instructions stored in the memory component(s) 225 to perform the functions described.

In other examples, the processor(s) also or instead include one or more graphics processing units (GPU), ASIC, FPGA, Tensor Processing Unit (TPU), Neural Processing Unit (NPU) or other type of component to execute a machine learning model that uses associations stored in memory based on previously processed training data to perform one or more of the functions represented by the various modules 211-219 shown in the FIG. 2 example. In some examples, a single machine learning model executing on the processor(s) may be used to implement all of the various functions of device 201. In other examples, dedicated machine learning models may operate independently of and/or in conjunctions with one another to implement the functions of device 201.

As also shown in FIG. 2, device 201 includes one or more display(s) 222. The display(s) 222 may be included as part of the device 201 as shown or part of another device communicatively coupled to the device 201 such as a smartphone, tablet, laptop computer, or the like. In some examples, where device 201 is a weapon scope, rangefinder, binocular, telescope or other long-range viewing device, the display(s) 222 may be integrated in the device 201 so as to augment the magnified view. In some examples, the device 201 may otherwise include a display screen that enables a user to view an image in real time as image data is captured by the image sensor(s) 220. In still other examples, the display(s) 222 may be implemented in glasses or contact lenses wearable by an operator of the device 201 and communicatively coupled to the device 201 to display images to the operator.

Although not shown in FIG. 2, the device 201 may further include or be communicatively coupled to control other means of communication with an operator beyond the display(s) 222. For example, the device 201 may further or instead include one or more speakers controllable to communicate alerts, alarms, or voice and/one or more haptic feedback mechanisms configured to vibrate device 201 to convey information to an operator.

Although not specifically depicted in FIG. 2, device 201 may also include one or more input mechanisms to receive user input such as a touchscreen interface, buttons, a keyboard, or the like configured to receive information from a user. In other examples, the device 201 may include a microphone to receive user input via voice commands or other sounds. In some examples, the device 201 be configured to access, executing on the processor(s) or through the communications interface 224, a large language model (LLM) to receive operator input via natural language voice, typed, and/or written commands, and/or to output information to an operator in natural language via sound projected through an audio speaker and/or text and/or other images on the display(s) 222.

As also shown in FIG. 2, the processor(s) 210 may implement an image processing module 211, a distance to target module 212, a type identification module 213, and a fingerprinting module 214. The processor(s) 210 may also implement a scoring module 215, an age estimation module 216, a compliance module 217, and an environment module 218. As mentioned above, the processor(s) 210 may be configured receive captured data from one or more sensor(s) 220, and compare the captured data to at least one reference, which may be a threshold and/or associations based on previously trained data when machine learning is used. The processor(s) 210 may use determine characteristics of one or more biological target(s) 102 and/or the environment 104 to assist an operator to hunt the biological target(s).

The image processing module 211 is configured to receive image data from the image sensor(s) 220 and process the image data for use by other functions of device 201. For example, image processing module 211 to receive analog or digital image data from the image sensor(s) 220 and identify pixels with common characteristics in the image data to identify objects in the image data and extract information from the image data to classify and label the identified objects.

In some examples, the image processing module 221 may include a visual machine learning model configured to process image data to distinguish different objects from one another in a captured image. For example, such a visual machine learning module may have been trained on training data showing images of man-made and/or natural objects that may potentially appear within the field of view of the image sensor(s) 220, to distinguish different objects in the image data and label them for further use. In some examples, the visual machine learning module may be particularly configured to identify an object as an animal in image data from the image sensor(s) 220 and identify the animal as a potential biological target the operator of device 201 that may seek to harvest. For example, the visual machine learning module may be configured to analyze a size, shape, outline, movement, distinguishing features, non-limiting examples of which include antlers, horns, claws, tails, hooves, paws, fur color, shape, texture, or other characteristics to determine a general type or species of an animal as a potential biological target. In other examples where the device 201 includes one or more image sensor(s) 220 configured to detect infrared light may also or instead utilize a thermal footprint, breathing pattern, or other characteristic of thermal imaging data to identify a particular object as a potential biological target.

As mentioned above, the image processing module 211 may identify objects in image data and label the image data for further use. In some examples, the image processing module 211 may further process image data associated with certain objects in the field of view to analyze movement of the objects. For example, the image processing module 211 may process image data to track and/or predict movement of a biological target 102 once it has been identified. In some examples, the image processing module 211 may further track movement of other non-target objects in the image data to assess an environment of the identified biological target 102, including the speed, direction, orientation, or other characteristic of wind. In some examples, the image processing module 211 may be configured to process image data associated with locations not physically occupied by the enhanced optical device 201/operator, including locations distal from the enhanced optical device 201/operator to assess an environment 104 associated with identified biological target 102, including the speed, direction, orientation, temperature or other characteristic of wind at distal locations.

The various modules 212-218 depicted in FIG. 2 may use data from the image processing module 211 to assess biological target(s) 102 and/or environment(s) 104 associated with biological target(s) 102 and perform functions to assist an operator to hunt the biological target(s) 102.

As shown in FIG. 2, device 201 further includes the distance to target module 212, which may automatically determine a distance to a detected biological target 102 or other object, i.e., a distance measured relative to a location of device 201. In some examples, the distance to target module 212 may use a laser-based sensor such as time-of-flight or other similar sensor configured to measure timing of reflected light to measure distance.

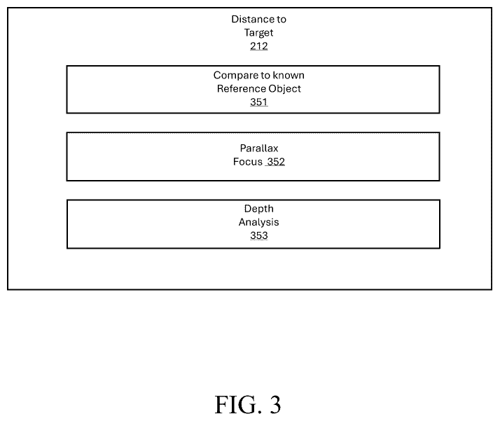

In other examples, the distance to target module 212 may not use a dedicated sensor to determine distance, and instead use image data or other data that does not require a dedicated time-of-flight or other laser-based sensor. FIG. 3 is a block diagram showing some examples of techniques that may be used to determine a distance between the device 201 and a biological target 102 or other object. As shown in FIG. 3, at 351 the distance to target module 212 may be configured to identify an object (e.g., a building, sign, tree, rock, boulder, hill, mountain, etc.) with a known dimension (e.g., height, width, depth, etc.) and determine a distance between the device 201 and the biological target 102 or object based on the known dimension. As shown in FIG. 3, at 353, where device 201 includes an optical scope with an adjustable parallax feature, the distance to target module 212 may determine a distance a biological target 102 or other object to based on a position of the adjustable parallax when an object seen through the optical scope is in focus. According to these examples, a machine learning model executing on the processor(s) 210 may be trained to distinguish between focused and unfocused image data to identify the adjustable parallax position to estimate a distance between the device 201 and a biological target or other object. According to another example, at 353 in FIG. 3, the distance to target module 212 may utilize image data collected by more than one image sensor 220 separated from one another by a distance, and perform depth analysis between the different image data from the multiple image sensors 220 to estimate a distance to a biological target 102 or other object.

In some examples, the distance to target module 212 may communicate a determined distance to an operator to assist the operator in hunting, for example via text or other cues presented on a display and/or by audio, voice, or otherwise. In examples where the distance to target module 212 is configured to automatically determine a distance to an object without using a dedicated sensor may reduce the cost associated with an additional dedicated sensor and/or dedicated device (e.g., rangefinder) to measure the distance. According to such examples, the enhanced optical device 201 may enable an operator to hunt with reduced cost and/or with carrying additional equipment to the field to measure a distance to a biological target or other object.

In some examples where the distance to target module 212 is implemented without laser-based sensors to measure a distance, the distance to target module 212 may enable an operator to avoid detection by equipment used to detect lasers, which may potentially save lives when used for military, law enforcement or other purposes.

Referring back to FIG. 2, the enhanced optical device 201 may further include a type identification module 213. The type identification module 213 is configured to compare image data and/or other data to a reference determine a animal type of a biological target 102, i.e., a species, sub-species, or other categorization of the biological target according to known classifications of animals. For example, the type identification module 213 may determine type for a biological target 102 as a deer, sheep, goat, bear, wolf, or other commonly hunted animal. In other examples, the type identification module 213 may identify a biological target more specifically as a particular species or sub-species, e.g., a white tailed deer, a black bear, a grizzly bear, or the like.

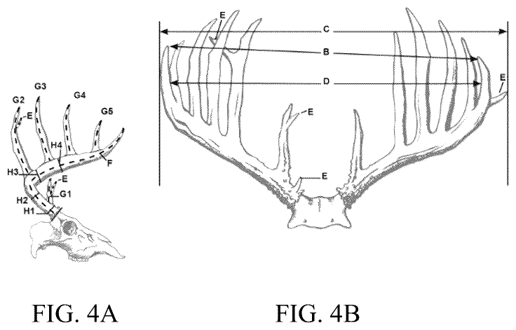

As shown in FIG. 2, device 201 further includes a scoring module 214. The scoring module 214 may determine a score for a biological target 102 based on a determined animal type. For example, the scoring module 214 may determine characteristics of a biological target 102 based on comparing image data to a static reference such as dimension(s) associated with one or more distinguishing features of a particular identified animal type. The scoring module 214 may then compare the measurements to one or more known references to determine a score for the biological target 102. For example, the scoring module 214 may compare a determined size of biological target 102 feature(s) to one or more thresholds based on scoring criteria published by firms such as Pope & Young, and Boone & Crockett to determine a score for the biological target 102. FIGS. 4A-4B, 5A-5B, and 6A-6B depict features of particular animals used to for scoring according to the Boone & Crockett criteria according to some embodiments. Other criteria such as the Pope & Young criteria may also be used by the scoring module 214 to score biological target(s) 102. In some examples, the scoring module 214 may be implemented using a machine learning module configured to compare image data to a dynamic reference including previously processed image data of already scored animals as a reference instead of a static reference (e.g., dimensions) as described above. In some examples, whether based on dimension(s) as a reference or otherwise, the scoring module 214 may be configured to take into account an impact that a relative distance and/or angle between the enhanced optical device 201 has on a static and/or dynamic reference as described above a biological target 102.

In some examples, the scoring module 214 dynamically adjusts the score in real-time by compensating for variables such as the angle of observation, distance to the target, and lighting conditions, as derived from image data processed by the image processing module 211, ensuring accurate scoring regardless of an orientation or position of the biological target(s) 102 relative to the device 201.

FIGS. 4A and 4B are diagrams showing non-limiting examples of measurements of the features of a deer which may be used to score the deer according to some embodiments. The measurements depicted may be automatically determined by the scoring module 214 of the enhanced optical device 201 based on processing captured image data or other data as depicted in FIG. 2 and described above. As shown in FIG. 4A, scoring metrics for the depicted deer may include: G-1 to G7 a length of a first through seventh points of the antlers; H1: a circumference at a smallest place between a burr and first points of the antler; H2: a circumference at a smallest place between first and second points of an antler; H3: a circumference at a smallest place between second and third points of an antler; H4: a circumference at a smallest place between third and fourth points of an antler. As shown in FIG. 4B, scoring metrics for the depicted deer may further include A: a number of points of the antler; B a tip-to-tip spread of the antlers; C a greatest spread between the main beams of the antler; D, an inside spread of the main beams of the antler; and/or E: a total length of abnormal points of the antler.

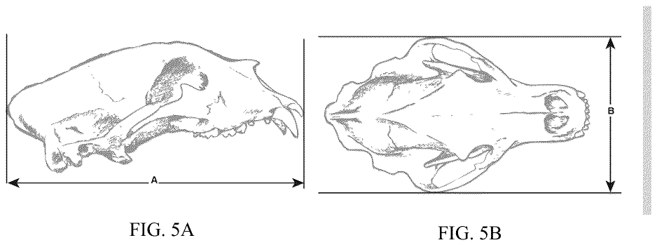

FIGS. 5A and 5B are diagrams showing example measurements of the features which may be used to score a bear according to some embodiments. The measurements depicted may be automatically determined by a scoring module 214 of the enhanced optical device 201 device based on processing captured image data or other data as depicted in FIG. 2 and described above. As shown in FIG. 5A, scoring metrics for the depicted bear may include A: a greatest length is measured between perpendiculars parallel to the long axis of the skull, without the lower jaw and excluding malformations. As shown in FIG. 5B, scoring metrics for the depicted bear may further include B: a greatest width measured between perpendiculars at right angles to the long axis.

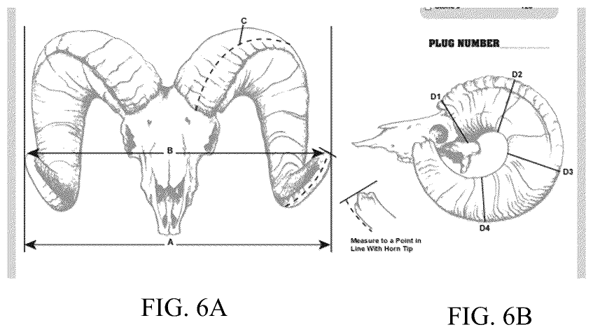

FIGS. 6A and 6B are diagrams showing example measurements of the features which may be used to score a sheep according to some embodiments. The measurements depicted may be automatically determined by a scoring module 214 of the enhanced optical device 201 based on processing captured image data or other data as depicted in FIG. 2 and described above. As shown in FIG. 6A, scoring metrics for the depicted sheep may include A: a greatest spread measured between perpendiculars at a right angle to the center line of the skull; B: a tip to tip spread; C: a length of horns. As shown in FIG. 6B, scoring metrics for the depicted sheep may further include D-1: a circumference of the base measured at a right angle to the axis of the horn; and D-2 to D4: a circumference at 1st, 2nd, and 3rd quarters of the horn as shown.

In some examples, the scoring module 214 depicted in FIG. 2 may offer significant advantages to operators of the enhanced optical device 201. Traditionally, animals harvested by hunters are scored by manually comparing animal characteristics to published criteria after an animal has already been harvested, which may present a risk to inexperienced hunters who might unknowingly violate rules or regulations for when the harvesting of a particular animal is appropriate and legal. In contrast, device 201 may enable even inexperienced hunters to score a biological target 102 before even harvesting the biological target 102. In addition to enabling a biological target 102 to be scored before being harvested, device 201 may further enable hunters to bring less equipment to the field even when scoring a biological target 102 after harvest. Specifically, device 201 enables hunters to leave behind equipment usually used to perform measurement or score biological target(s) 102.

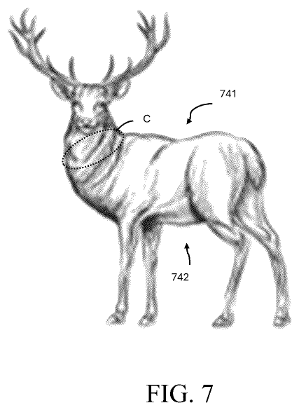

Referring back to FIG. 2, the enhanced optical device 201 further includes an age estimation module 215. The age estimation module 215 is configured to estimate, based on comparing image data and/or other data to a reference, an age of one or more biological target(s) 102. FIG. 7 is a diagram that shows some non-limiting examples of measurements that might be used to estimate an age applied to a white-tailed deer according to some embodiments. As shown in FIG. 7, the age estimation module 215 may process image data to compare a measured measure a spine sway 741 of a biological target 102 to a reference. In other examples, the age estimation module 215 may also or instead compare a relative curve of belly sag 742 of a biological target 102 to a reference. In other examples, the age estimation module 215 may also or instead compare a neck circumference C of the biological target 102 to a reference. In still other examples not shown in FIG. 7, the age estimation may analyze facial features, a gait of the biological target 102 when moving, and/or identified signs of sexual dimorphism in the biological target 102 to estimate an age of the biological target.

Referring back to FIG. 2, device 201 may further include a compliance module 216. The compliance module 216 may determine whether characteristics of a biological target 102 meet minimum requirements for harvesting the biological target based on the animal type. To determine whether a biological target 102 may be legal harvested, the compliance module 216 may compare determined characteristics of a biological target to one or more known rules as a reference. For example, where relevant government regulations prohibit harvesting a particular animal type unless the biological target meets a minimum score determined by the scoring module 214, the compliance module 216 may determine whether a particular biological target 102 is legal to harvest based on whether a score for a particular animal exceeds the minimum score for the type of animal. In other examples, where relevant government regulation prohibits harvesting a particular animal type unless the biological target 102 is at least a minimum age, the compliance module 216 may determine whether a particular biological target is legal to harvest based one whether an estimated age for the biological target 102 meet or exceeds the minimum age. In some examples, the compliance module 216 may be configured to generate a visual, audio, and/or haptic alarm if an identified biological target meets or exceeds a minimum score/age. In other examples, the compliance module 216 may also or instead be configured to output a visual, audio, or haptic warning when a particular identified biological target 102 does not meet or exceed a minimum score/age to warn the operator not to harvest the biological target 102.

In some examples, regardless of whether based on a score, age or other metric, a minimum threshold (e.g., minimum score, age) used by the compliance module 216 to indicate whether or not to harvest a biological target is legal may be predetermined and stored in memory 226 or otherwise accessible via a network to the compliance module 216 to perform the comparison. In some examples, the compliance module 216 may be configured to access jurisdictional data (e.g., global positioning system (GPS) linked regulation databases) to automatically update one or minimum threshold(s) used by the compliance module 216. In some examples, device 201 includes one or more settings that are adjustable by an operator based on user input. According to such examples, an operator may be enable an operator to raise the minimum threshold, e.g., increase a minimum score and/or minimum age at which the device 201 notifies an operator to harvest (or not to harvest) a target to reduce a risk of violating a rule or regulation. Accordingly, device 201 may not only enable operators to hunt with more certainly and without additional field equipment to perform measurements for scoring or age analysis, the enhanced optical device 201 may further enable an operator to select a particular risk tolerance associated with legal compliance. In some examples, such a setting may be specific to different animal types and different rules and regulations that apply in different jurisdictions.

As mentioned above, in some examples, the compliance module 216 may be access one or more threshold(s) stored in memory(s) 226 or otherwise accessible via a network to determined whether a particular biological target is compliant to harvest. In other examples, the compliance module 216 may automatically determine what particular rules, and thresholds, apply for a particular biological target at a particular location. As an example, the compliance module 216 may access global positioning system GPS data, map data, or other data that may indicate a jurisdiction in which the biological target is located or expected to be located, and automatically identify the minimum threshold(s) that represent applicable regulations in that jurisdiction. In some examples, the compliance module 216 may automatically determine the jurisdiction and applicable to a particular biological target as device 201 is being used to view the biological target and/or capture image data of the biological target in real time. According to such examples, if a biological target crosses a geographical country, state, county, city, or other boundary, the compliance module 216 may accordingly compare characteristics of the biological target to the appropriate rules in response. In some examples, the compliance module 216 may be operable to notify an operator if a biological target 102 meets a minimum threshold, whether defined by score or age.

As shown in FIG. 2, the enhanced optical device 201 may further include a fingerprinting module 217. The fingerprinting module 217 may compare image data and/or other data to a reference identify a biological target 102 as a specific animal by fingerprinting the biological target 102. For example, the fingerprinting module 217 may extract characteristics that are unique between animals of the same species or type. For example, the fingerprinting module 217 may be configured to extract image data of known features of a particular type of animal analogous to fingerprints or iris patterns in human beings. For example, the fingerprinting module 217 may be configured to extract a particular identifying antler or horn pattern, fur pattern, claw/hoof print, optical iris characteristic, measured gait, recorded audible sound made by an animal like the particular growl of a bear or howl of a wolf, or other fingerprinting characteristic unique to each particular animal.

In some examples, the fingerprinting module 217 may be configured to store extracted data identifying a particular animal locally and/or through a cloud networked database. In some examples, the fingerprinting module 217 may access such a database seeking previously recorded information regarding the location or movement of the particular animal from the enhanced optical device 201, another device, or manual user input. In some examples, such fingerprinting data may be stored with other data associated with a particular biological target 102 such as a score for the animal, an overall size of the animal (height, width, weight, etc.) measured dimensions of features of the biological target 102 including features used to score an biological target 102, an estimated age of the biological target 102, or other data associated with the particular biological target 102.

The fingerprinting module 217 may be configured notify an operator if a particular animal that was flagged as of interest has been identified image data from the image sensor(s) 220 or other data. For example, when a particular animal is identified by the fingerprinting module 217, the fingerprinting module 217 may solicit input from an operator indicating the particular animal is of interest to the operator. If the particular animal is subsequently identified by the fingerprinting module 217, the fingerprinting module 217 may notify the operator in real time. For example, where the enhanced optical device 201 is part of hunting equipment like the scope of a weapon or rangefinder, the enhanced optical device 201 may notify the operator in real time with a visual, audio, haptic, and/or other alert that the flagged animal of interest has been detected in image data from the image sensor(s) 220. In other examples where the enhanced optical device 201 is part of equipment remote from the operator such as a trail camera, the enhanced optical device 201 may cause an alert to be output through a smartphone, tablet, or other personal device of the operator through a network. In some examples, the fingerprinting module 217 may use information from multiple devices including the enhanced optical device 201 over a network to fingerprint a particular biological target. As an example where the enhanced optical device 201 is a handheld device such a gun scope, bow scope, rangefinder, or other long-distance viewing device, the enhanced optical device 201 may be configured to access image and/or other data from one or more trail cameras or other distinct devices via a network to access fingerprinting data.

In some examples, the enhanced optical device 201 may cause an alert to be output that also indicates other information associate with the particular biological target 102 including but not limited to a score for the biological target 102, an overall size of the biological target 102 (height, width, weight, etc.) measured dimensions of features of the biological target 102 including features used to score the biological target 102, an estimated age of the biological target 102, or other data associated with the particular the biological target 102. In some examples, the fingerprinting module 217 may be further configured to access cloud-sourced, local, or other data to present a visible map showing movements of a particular biological target 102 over time, including locations and/or dates/times where the particular biological target 102 has been previously identified, or otherwise convey such information to an operator.

As shown in FIG. 2, the enhanced optical device 201 is may further include an environment module 218. The environment module 218 is configured to analyze image data to determine one or more characteristics of an environment 104 associated with a biological target 102, including in an area an operator seeks to hunt and/or an area in which a biological target 102 is already known to be located. In some examples, the environment module 218 is configured to process image data associated with objects in proximity to the enhanced optical device 201 as well as objects located distally from the enhanced optical device 201. The environmental module 218 may be configured to determine characteristics of the wind such as speed, magnitude, orientation and/or temperature at locations distal from the enhanced optical device 201/operator (not physically occupied by the operator/enhanced optical device 201) based on processing image data associated with an area. The environmental module 218 may also determine characteristics of terrain in an environment associated with biological target(s) 102. In some examples, the environment module 218 may be use determined characteristics to assist an operator to harvest biological target(s) 102. In some examples, the environmental module 218 may be configured to perform environmental analysis such as wind analysis using visual cues in image data alone, i.e., without dedicated equipment to sense wind direction speed such as an anemometer.

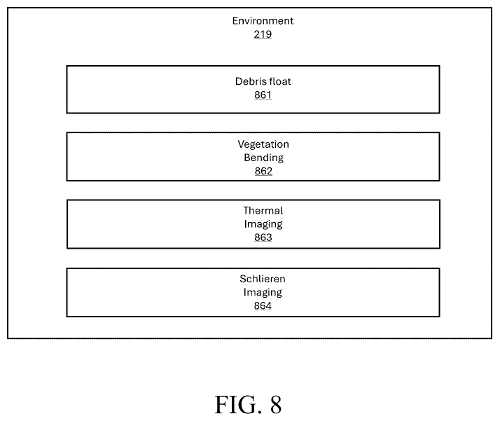

FIG. 8 is a block diagram depicting non-limiting examples of techniques that may be used to determine at least one characteristic of wind or air to assist an operator to hunt. As shown in FIG. 8, at 861, the environmental module 218 may process image data to identify and track debris such as garbage, dead vegetation (i.e., leaves), or the like floating in wind determine one or more of a direction, speed, and/or orientation of the wind. As shown in FIG. 8, at 862, the environmental module 218 may process image data to detect the bending of vegetation such as trees, branches, leaves, bushes, shrubs, grasses, or the like to determine one or more of a direction, speed, and/or orientation of the wind. The environment module 218 may determine characteristics of wind at both at locations proximal to the enhanced optical device as well as at locations distal from the enhanced optical device 201, such as where a biological target 102 is expected to be and/or is located.

As shown in FIG. 8, the environment module 219 may also or instead utilize thermal imaging 863 to determine characteristics of wind or air, including an absolute or relative temperature of wind or air, for example where the enhanced optical device 201 includes image sensors 220 configured to detect infrared light. As shown in FIG. 8, the environment module 218 may use Schlieren Imaging 864 on image data to make invisible flow elements, such as air, visible to determine one or more of a direction, path, temperature, speed or other characteristic of wind. In some examples, the environmental module 218 may further use schlieren imaging to visualize wind superimposed over images of a 2D or 3D map of an area via one or more display(s) 222.

In some examples, the environmental module 218 may analyze characteristics of wind in the direct vicinity of identified biological target(s) 102 (i.e., at a location distal from the enhanced optical device 201, i.e., based on movement of objects in the immediate vicinity of the identified biological target. In other examples, the environmental module may analyze characteristics of wind across a geographical area or region in which biological target(s) 102 are expected to be in the future and/or where the operator plans to hunt.

In some examples, the environment module 218 may cause a representation of the wind direction and/or speed in the vicinity of the biological target to be presented in images by the display(s) 222 so that an operator can account for the impact of wind on whether biological targets in a particular area are likely to be able to detect a scent of the operator, or otherwise detect the presence of the operator or other humans that might startle a biological target. For example, the environment module 218 may cause images on the display showing wind direction, speed, and orientation relative to terrain features in an area where biological target(s) 102 are most likely to travel or congregate so that the operator can position themselves downwind of the area.

In some examples, the environment module 218 may further determine characteristics of terrain in an environment of a biological target 102, such as to identify elevation of objects in the environment and/or to identify geological features within the environment. For example, the environment module 218 may process image data and/or access location/mapping data to determine an absolute elevation of a biological target or other object in the environment (i.e., 300 feet above sea level). In other examples, the environment module 219 to determine based on processing image or other data a relative elevation of a biological target 102 or other object (e.g., an elevation at the target is 10 meters higher than an elevation local to the device 201.

An operator may use the enhanced optical device 201 to improve and or make the act of hunting more efficient, easier, and/or enjoyable, when planning a hunt and/or when actively targeting an biological target 102 for harvesting. For example, in a planning phase, an operator may point the enhanced optical device 201 in a direction to detect image data associated with an area where the operator seeks to hunt, and scan that area to capture image data including of objects in the area. The enhanced optical device 201 may process such image data or other data to determine characteristics of terrain in the area and identify aspects of the environment in that area such characteristics of wind (speed, direction, temperature, orientation), weather (precipitation, temperature, etc.), season (spring, fall, summer winter), geographical location, and/or time of day (morning, noon, evening, night). The enhanced optical device 201 may output such information to the operator to enable the operator to determine routes that animals may be likely travel or congregate.

In some examples, the enhanced optical device 201 may operate the display(s) 222 to present an operator with a 2D or 3D representation of an area with geological features, wind speed/direction, temperature and the like shown at different positions across the area, for example using Schlerien imaging. In some examples, the enhanced optical device 201 may further predict and present via a display(s) 222 likely positions, paths, and/or directions of movement of potential biological target(s) 102 relative to the mapped area. In some examples, the enhanced optical device 201 may determine and present via the display(s) 222 likely positions, paths, and/or directions of movement of potential biological target(s) 102 at different times of day, for example to accommodate for anticipated changes in wind direction, temperature, or other environmental characteristic of the scanned area.

The enhanced optical device 201 may further indicate to an operator where biological target(s) 102 (including specific biological target(s) identified by the fingerprinting module 217) have historically been detected or successfully hunted in the past based on previously stored local and/or networked data such as cloud-sourced data.

In some examples, the enhanced optical device 201 may be configured to analyze image data and/or other data in an area scanned by the enhanced optical device 201 to determine one or more optimal hunting positions within the scanned area where the operator is most likely to encounter potential biological targets biological target(s) 102 and/or to avoid detection, including locations where the operator mostly likely to be downwind where biological target(s) 102 are expected to be. For example, the enhanced optical device may be configured to operate the displays to present an image of the scanned area, and identify through colors, markings text or the like potential positions from which the operator may have a best chance of success and/or where the operator might position a tree stand or blind. The enhanced optical device 201 may further predict such locations for future times and present the same to an operator based on accessing weather forecasts over a network and/or based on predictable daily heating and cooling patterns. For example, the enhanced optical device may suggest a different optimal location/elevations in the morning when warmth causes air to rise compared to the evening when air tends to fall.

In some examples, the enhanced optical device 201 identify geological features and provide suggestions to an operator of optimal positions to hunt relative to the geological feature. For example, the enhanced optical device 201 may process image data or access mapping or location data to identify one or more ridges in an area. The enhanced optical device 201 may further identify a “bench” which is flat area between relatively steep sections along side a ridge where animals may be likely to travel and/or congregate. The enhanced optical device 201 may determine a (current and/or future) wind speed and direction relative to the bench and suggest positions relative to the bench to remain downwind of the bench. As an example, the enhanced optical device determines that (current or future) wind speed is relatively low and thermal drafts may impact an ability of biological targets 102 on the bench from detecting the operator's scent. According to this example, the enhanced optical device 201 may account for the time of day and suggest a position with higher elevation relative to the bench in the morning hours when heat causes air to rise to remain downwind of the bench, or suggest a position with a lower elevation relative to the bench in the evening hours when cooler temperatures typically cause air to fall.

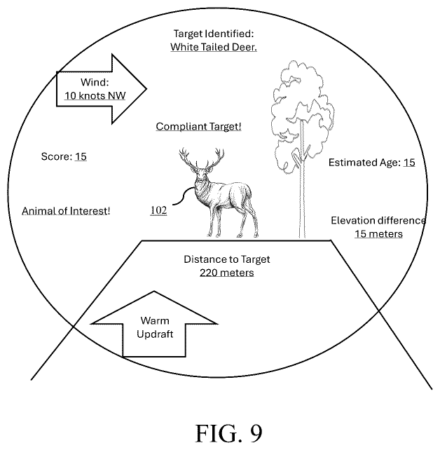

FIG. 9 is a diagram depicting a biological target 102, a deer, visible through the scope of long-distance viewing feature of a weapon, rangefinder or the like. As shown in the FIG. 9 diagram, in some examples, an operator may use the enhanced optical device 201 to continually scan an area in search of potential biological target(s) 102 and continually process newly captured image data of the area and provide updated information to the operator in real-time, including information relating to an environment distal from the enhanced optical device 201. If a potential biological target 102 is detected, the enhanced optical device 201 may provide information to assist the operator to harvest (e. g, shoot or otherwise kill or incapacitate) the biological target(s) 102. For example, once a potential biological target 102 is identified (e.g., as a live animal that may be a candidate to hunt), the enhanced optical device 201 may process the information to determine a distance to the biological target(s) 102, an animal type of the biological target(s) 102, a score for the biological target(s) 102 based on the determined type, fingerprint the biological target(s) 102, and/or to analyze an environment 104 associated with biological target(s) 102 and provide such information to the operator. For example, FIG. 9 shows the enhanced optical device 201 operated cause one or more displays 222 to supplement a magnified image of a biological target 102 augmented with information potentially useful to the operator to hunt the biological target 102 according to some embodiments.

In the example of FIG. 9, the enhanced optical device 201 has caused a display 222 to show a determined type of a biological target 102, shown the text “Target Identified: White Tailed Deer”. As shown in FIG. 9, the enhanced optical device 201 has caused the display 222 to show a determined score for the biological target 102, shown as the text “Score: 15.” As shown in FIG. 9, the enhanced optical device 201 has caused the display 222 to show a determined estimated age for the biological target as shown by the test “Estimated Age: 7.” As shown in FIG. 9, the enhanced optical device 201 has caused the display 222 to indicate confirmation that the biological target 102 complies with applicable regulations as shown by the text “Compliant Target!” As shown in FIG. 9, the enhanced optical device 201 has caused the display 222 to show a determined distance to the target, as shown by the text “220 meters to target.” As shown in FIG. 9, the enhanced optical device 201 has caused the display 222 to show a determined difference in relative elevation between the enhanced optical device 201 and the biological target 102, shown by the text “Elevation Difference: 15 meters.” As shown in FIG. 9, the enhanced optical device 201 has caused the display 222 to show wind speed and direction information in the immediate vicinity of the biological target as shown by the text “10 knots NW” and the arrow labeled “warm updraft.” As shown in FIG. 9, the enhanced optical device 201 has caused the display 222 to identify the biological target as a specific animal previously identified as of interest to a user as shown by the text “Animal of interest!” in FIG. 9.

The enhanced optical device 201 described herein may seamlessly perform multiple functions in real-time to assist the operator to harvest an animal and or strategically plan a hunt. In some examples, the enhanced optical device 201 may simplify the act of hunting and potentially enable inexperienced or unsure operators to learn to hunt with little or no background knowledge. In some examples, the enhanced optical device 201 may enable experienced and inexperienced users alike to bring less equipment to the field and/or focus more time and energy on enjoying a hunt and surrounding nature than they could previously using traditional equipment.

As set forth above, at least some of the various modules 211-218 depicted in FIG. 2, which represent functions that may be performed by the enhanced optical device 201, may be implemented with traditional rules-based software that operates based on executing instructions stored in a memory. In other examples, the various modules 211-218 may be implemented by one or multiple machine learning module configured to operate based on associations learned based on previously processing analogous data. In some examples, one or more of the modules 211-218 may be implemented by a single machine learning module executing on processors in the device 201 or elsewhere and configured to perform the described functions. In other examples, one or more of the modules 211-218 may be implemented by independent machine learning modules dedicated to the particular function. FIG. 6 is a block diagram that depicts a plurality of independent machine learning module that may be executed by the same or a different processor to perform at least some of the functions of device 201.

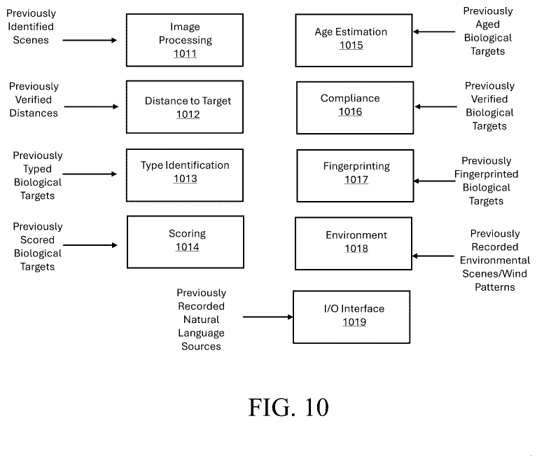

FIG. 10 is a block diagram that depicts some examples of machine learning models that may be used to implement functions of the enhanced optical device 201 according to some embodiment. As shown in FIG. 10, the enhanced optical device 201 may include a machine learning model 1011 to implement the image processing module 211 depicted in FIG. 2. According to this example, the machine learning model 1011 may be trained on previously identified scenes as a reference similar to common hunting environments that include images with objects commonly found in hunting environments such as terrain, vegetation, animals, birds, insects, and the like. Based on such previous training, the machine learning model 1011 may compare captured image data to known associations to label objects detected in image data. For example, the machine learning model 1011 may be particularly configured to detect animals in image data that may be potential biological target(s) 102 for hunting. As another example, the machine learning model 1011 may be particularly configured to detect movement of non-target objects in image data to determine characteristics of an environment associated with biological target(s) 102.

As also shown in FIG. 10, the enhanced optical device 201 may include a machine learning model 1012 to implement the distance to target module 212 depicted in FIG. 2. According to this example, the machine learning model 1012 may be trained on previously measured distances to objects in scenes as a reference depicting common hunting environments that include images with objects commonly found in hunting environments such as terrain, vegetation, animals, birds, insects, and the like. Based on such previous training, the machine learning model 1012 may identify an estimated distance to a biological target 102 or other object without using a dedicated laser-based sensor to perform other functions of the enhanced optical device 201 and/or communicate the same to an operator. Based on such previous training, the machine learning model 1011 may compare captured image data to known associations as a reference to determine a distance to one or more objects detected in image data.

As shown in FIG. 10, the enhanced optical device 201 may include a machine learning model 1013 to implement the type identification module 613. According to this example, the machine learning model 1013 may be trained on previously recorded image data showing previously identified animal species, sub-species, or other known animal categorizations. Based on such previous training, the machine learning model 1013 may compare captured image data to known associations as a reference to identify a type of a particular biological target and use the determined type to perform other functions of the enhanced optical device 201 and/or communicate the same to an operator.

As also shown in FIG. 10, the enhanced optical device 201 may include a machine learning model 1014 to implement the scoring module 214. According to this example, the machine learning model 1014 may be trained on previously recorded image data showing previously scored animals of the same or different animal type as a reference. Based on such previous training, the machine learning model 1014 may compare captured image data to known associations as a reference to assign a score a biological target and use the determined score to perform other functions of the enhanced optical device 201 and/or communicate the same to an operator.

As also shown in FIG. 10, the device 201 may include a machine learning model 1015 to implement the age estimation module 215. According to this example, the machine learning model 1015 may be trained on previously recorded image data showing animals of the same or different animal type with a known age. Based on such previous training, the machine learning model 1015 may estimate an age of biological target(s) 102 and use the estimated age to perform other functions of the enhanced optical device 201 and/or communicate the same to an operator.

As also shown in FIG. 10, the device 201 may include a machine learning module 1016 to implement the compliance module 216. According to this example, the machine learning module 1016 may be trained on previously recorded image data showing animals that were previously determined to comply with rules in a local jurisdiction for harvesting animals by hunting. In some examples, the machine learning module 1016 may be configured to consider a geographical location associated with the device and/or a biological target and determine compliance in light of rules of a jurisdiction associated with the geographical location. Based on such previous training, the machine learning module 1016 may compare captured image data to known associations as a reference to determine whether a biological target is compliant to perform other functions of the enhanced optical device 201 and/or to communicate the same to an operator.

As also shown in FIG. 10, the enhanced optical device 201 may include a machine learning model 1017 to implement the fingerprinting module 217. According to this example, the machine learning model 1017 may be trained on previously stored image data showing animals that were previously identified as a unique animal based on one or more defining characteristics associated with different animal types. Based on such previous training, the machine learning model 1017 may compare captured image data to known associations as a reference to identify a biological target as a particular animal to perform other functions of the enhanced optical device 201 and/or to communicate the same to an operator.

As also shown in FIG. 10, the enhanced optical device 201 may include a machine learning model 1018 to implement the environment module 218. According to this example, the machine learning model 1018 may be trained on previously recorded image data showing wind, precipitation, elevation and/or other environmental factors impacting objects in scenes in environmental characteristics are known. Based on such previous training, the machine learning model 1018 may compare captured image data to known associations as a reference to determine characteristics of an environment 104 such as characteristics of wind to perform other functions of the enhanced optical device 201 and/or communicate the same to an operator.

As also shown in FIG. 10, the enhanced optical device 201 may include a machine learning model 1070 to operate as part an I/O interface of the enhanced optical device 201 to communicate with an operator. For example, the machine learning model 1070 may be a large language model (LLM) trained on documents to receive user input via natural language (e.g., via a keyboard or microphone), and/or provide a user with information via natural language in response (e.g., via speakers or a display 222).

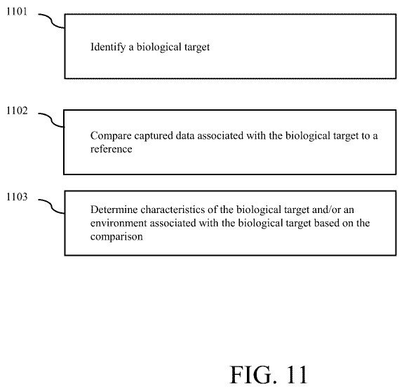

FIG. 11 is a flow diagram that depicts one example of a method of operating an enhanced optical device 201 according to some embodiments. As shown in FIG. 11, at 1101, the method includes identifying a biological target 102 in the field of view of the one or more sensors. As shown in FIG. 11, at 1102, the method includes comparing captured image data associated with the biological target 102 as a reference. As shown in FIG. 11, at 1103, the method further includes determining characteristics of one or more of the biological target 102 and an environment 104 associated with the biological target 102 based on the comparison.

In some examples, the method further includes using the determined characteristics to assist an operator in hunting the biological target 102. In some examples, the method further includes identifying an animal type of the biological target 102. In some examples, the method further includes determining whether the characteristics of the biological target 102 meet minimum requirements for harvesting the biological target 102 based on the identified animal type. In some examples, the method further includes determining a score for the biological target 102 based on the identified animal type. In some examples, the method further includes determining a minimum score associated with the identified animal type, and determining whether the score for the biological target 102 meets the minimum score associated with the identified animal type. In some examples, the method further includes automatically determining the minimum score based on a geographical location of the biological target 102. In some examples, the method further includes notifying an operator if an identified biological target meets the minimum score associated with the determined animal type. In some examples, the minimum score is adjustable by an operator based on user input.

In some examples, the method further includes determining an estimated age of the biological target 102. In some examples, the method further includes determining an age of the biological target 102 based on one or more of: a measured spine sway of the biological target 102, a measured belly sag of the biological target 102, a measured circumference of a neck of a biological target 102, analysis of facial features of the biological target 102, analysis of a gait of the biological target 102, and identified signs of sexual dimorphism of the biological target 102.

In some examples, the method further includes identifying the biological target 102 as a specific animal by fingerprinting the biological target 102. In some examples, the method further includes notifying an operator if the biological target 102 is identified as a specific animal previously flagged by a user. In some examples, the method further includes outputting the characteristics of the biological target 102 via at least one display. In some examples, the method further includes using one or more displays to enable an operator to view an image of the biological target, and causing the characteristics of the biological target 102 to be output augmenting the image of the biological target 102. In some examples, the method further includes causing the characteristics of the biological target 102 to be output via a wireless communication network. In some examples, the reference comprises at least one threshold associated with one or more of: a main beam length of an antler, an inside spread of the antler, a circumference measurement, and a length of antler points.

In some examples, the method further includes using a machine learning model configured to compare the captured data to the reference, wherein the reference comprising training data that includes images of previously characterized biological targets or other objects processed by the machine learning module. In some examples, the method further includes using a first machine learning model configured to identify the biological target in the field of view of the one or more sensors, and using a second machine learning model configured to determine characteristics of the biological target based on the comparison. In some examples, the method further includes using a further machine learning model configured to estimate an age of the biological target 102.

In some examples, the method further includes a further machine learning module configured to determine characteristics of an environment associated with a biological target selected from the group consisting of wind speed, wind direction, wind temperature, weather conditions, and characteristics of terrain. In some examples, the method further includes using a further machine learning module configured to determine one or more of: a distance between the biological target and the device, a geographical location of the biological target 102, a relative elevation of the biological target, and an absolute elevation of the biological target 102. In some examples, the method further includes determining one or more characteristics of an environment 104 associated with an area, and providing a user with one or more optimal locations to harvest the biological target 102 based on the one or more characteristics of the environment 104.

In some examples, the method further includes analyzing image data to determine a distance to a biological target 102 or other object based on one or more of: a size of the biological target 102 relative to an object in the field of view with a known dimension, a position of a parallax adjustment mechanism when an object is in focus, and comparison of image data from at least two image sensors separated by a distance.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A device, comprising:
a processor configured to receive captured data from one or more sensors and used the captured data to:
compare the captured data associated with a biological target to at least one reference; and
determine characteristics of the biological target and an environment associated with the biological target based on the comparison.

2. The device of claim 1, further comprising:
using the characteristics to assist an operator in hunting the biological target.

3. The device of claim 1, wherein the processor is further configured to:
identify an animal type of the biological target.

4. The device of claim 3, wherein the processor is further configured to:
determine whether the characteristics of the biological target meet minimum requirements for harvesting the biological target based on the identified animal type.

5. The device of claim 3, wherein the processor is further configured to:
determine a score for the biological target based on the identified animal type.

6. The device of claim 3, wherein the processor is further configured to:
determine a minimum score associated with the identified animal type; and
determine whether the score for the biological target meets the minimum score associated with the identified animal type.

7. The device of claim 6, wherein the processor is configured to:
automatically determine the minimum score based on a geographical location of the biological target.

8. The device of claim 6, wherein the processor is further configured to:
notify an operator if an identified biological target meets the minimum score associated with the determined animal type.

9. The device of claim 6, wherein the minimum score is adjustable by an operator based on user input.

10. The device of claim 1, wherein the processor is further configured to:
determine an estimated age of the biological target.

11. The device of claim 10, wherein the processor is configured to determine an age of the biological target based on one or more of:
a measured spine sway of the biological target;
a measured belly sag of the biological target;
a measured circumference of a neck of a biological target;
analysis of facial features of the biological target;
analysis of a gait of the biological target; and
identified signs of sexual dimorphism of the biological target.

12. The device of claim 1, wherein the processor is configured to identify the biological target as a specific animal by fingerprinting the biological target.

13. The device of claim 12, wherein the processor is configured to notify an operator if the biological target is identified as a specific animal previously flagged by the operator.

14. The device of claim 1, wherein the processor is configured to output characteristics of the biological target via at least one display.

15. The device of claim 14, wherein the device comprises one or more displays configured to enable an operator to view an image of the biological target, and the processor is configured to cause the characteristics of the biological target to be output augmenting the image of the biological target.

16. The device of claim 14, wherein the processor is configured to cause the characteristics of the biological target to be output via a wireless communication network.

17. The device of claim 1, wherein the device comprises one or more of:
a pair of binoculars;
a telescope;
a rangefinder;
a spotting scope;
a gun scope;
a bow scope;
a wearable device;
a trail camera; and
a drone.

18. The device of claim 1, wherein the reference comprises at least one threshold associated with one or more of:
a main beam length of an antler;
an inside spread of the antler;
a circumference measurement; and
a length of antler points.

19. The device of claim 1, wherein the processor is communicatively coupled to:
a machine learning module configured to compare the captured data to the reference, wherein the reference comprising training data that includes images of previously analyzed biological targets and/or environments.

20. The device of claim 19, wherein the processor is communicatively coupled to:
a first trained machine learning module configured to identify the biological target in a field of view of the one or more sensors; and
a second trained machine learning module configured to determine characteristics of the biological target based on the comparison.

21. The device of claim 19, wherein the processor is communicatively coupled to:
a further machine learning module configured to estimate an age of the biological target.

22. The device of claim 19, further comprising:
a further machine learning module configured to determine characteristics of an environment associated with a biological target selected from a group consisting of:
wind speed;
wind direction;
wind temperature;
weather conditions; and
characteristics of terrain.

23. The device of claim 19, further comprising:
a further machine learning module configured to determine one or more of:
a distance between the biological target and the device;
a geographical location of the biological target;
an elevation of the biological target relative to the device; and
an absolute elevation of the biological target.

24. The device of claim 1, wherein the processor is configured to:
determine one or more environment characteristics associated with an area and provide an operator with one or more optimal locations to harvest based on the one or more environment characteristics.

25. The device of claim 1, wherein the one or more sensors include at least one camera sensor, the captured data includes image data in a field of view of the at least one camera sensor, and the processor is further configured to:
analyze the image data to determine a distance to the biological target based on one or more of:
a size of the biological target relative to an object in the field of view with a known dimension;
a position of a parallax adjustment mechanism when an object is in focus; and
comparison of image data from at least two image sensors separated by a distance.

26. A method, comprising:
identifying a biological target in a field of view of one or more sensors;
comparing captured image data associated with the biological target to a reference; and
determining characteristics of the biological target and an environment associated with the biological target based on the comparison.

27. The method of claim 26, further comprising:
using the determined characteristics to assist an operator in hunting the biological target.

28. The method of claim 26, further comprising:
identifying an animal type of the biological target.

29. The method of claim 28, further comprising:
determining whether the characteristics of the biological target meet minimum requirements for harvesting the biological target based on the identified animal type.

30. The method of claim 28, further comprising:
determining a score for the biological target based on the identified animal type.

31. The method of claim 28, further comprising:
determining a minimum score associated with the identified animal type; and
determining whether the score for the biological target meets the minimum score associated with the identified animal type.

32. The method of claim 31, automatically determining the minimum score based on a geographical location of the biological target.

33. The method of claim 31, further comprising:
notifying an operator if an identified biological target meets the minimum score associated with the determined animal type.

34. The method of claim 31, wherein the minimum score is adjustable by an operator based on user input.

35. The method of claim 26, further comprising:
determining an estimated age of the biological target.

36. The method of claim 35, further comprising:
determining an age of the biological target based on one or more of:
a measured spine sway of the biological target;
a measured belly sag of the biological target;
a measured circumference of a neck of a biological target;
analysis of facial features of the biological target;
analysis of a gait of the biological target; and
identified signs of sexual dimorphism of the biological target.

37. The method of claim 26, further comprising:
identifying the biological target as a specific animal by fingerprinting the biological target.

38. The method of claim 37, further comprising:
notifying an operator if the biological target is identified as a specific animal previously flagged by a user.

39. The method of claim 26, further comprising:
outputting the characteristics of the biological target via at least one display.

40. The method of claim 26, further comprising:
using one or more displays to enable an operator to view an image of the biological target; and
causing the characteristics of the biological target to be output augmenting the image of the biological target.

41. The method of claim 26, further comprising:
causing the characteristics of the biological target to be output via a wireless communication network.

42. The method of claim 26, wherein the reference comprises at least one threshold associated with one or more of:
a main beam length of an antler;
an inside spread of the antler;
a circumference measurement; and
a length of antler points.

43. The method of claim 26, further comprising:
using a machine learning model configured to compare the captured data to the reference, wherein the reference comprising training data that includes images of previously characterized biological targets.

44. The method of claim 43, further comprising:
using a first machine learning model configured to identify the biological target in the field of view of the one or more sensors; and
using a second machine learning model configured to determine characteristics of the biological target based on the comparison.

45. The method of claim further comprising:
using a further machine learning model configured to estimate an age of the biological target.

46. The method of claim further comprising:
a further machine learning module configured to determine characteristics of an environment associated with a biological target selected from the group consisting of:
wind speed;
wind direction;
wind temperature;
weather conditions; and
characteristics of terrain.

47. The method of claim further comprising:
using a further machine learning module configured to determine one or more of:
a distance to biological target;
a geographical location of the biological target;
a relative elevation of the biological target; and
an absolute elevation of the biological target.

48. The method of claim 26, further comprising:
determining one or more characteristics of an environment associated with an area; and providing a user with one or more optimal locations to harvest the biological target based on the one or more environment characteristics.

49. The method of claim 26, further comprising:
analyzing image data to determine a distance to a biological target based on one or more of:
a size of the biological target relative to an object in the field of view with a known dimension;
a position of a parallax adjustment mechanism when an object is in focus; and
comparison of image data from at least two image sensors separated by a distance.

50. A computer-readable medium that stores instructions configured to cause a computing device to:
identify a biological target in a field of view of one or more sensors;
compare captured image data associated with the biological target to a reference; and
determine characteristics of one or more of the biological target and an environment associated with the biological target based on the comparison.

51. The computer-readable medium of claim 50, further comprising instructions configured to cause the computing device to:
use the determined characteristics to assist an operator in hunting the biological target.

52. The computer-readable medium of claim 50, further comprising instructions configured to cause the computing device to:
identify an animal type of the biological target.

53. The computer-readable medium of claim 52, further comprising instructions configured to cause the computing device to:
determine whether the characteristics of the biological target meet minimum requirements for harvesting the biological target based on the identified animal type.

54. The computer-readable medium of claim 52, further comprising instructions configured to cause the computing device to:
determine a score for the biological target based on the identified animal type.

55. The computer-readable medium of claim 52, further comprising instructions configured to cause the computing device to:
determine a minimum score associated with the identified animal type; and
determine whether the score for the biological target meets the minimum score associated with the identified animal type.

56. The computer-readable medium of claim 55, further comprising instructions configured to cause the computing device to:
automatically determine the minimum score based on a geographical location of the biological target.

57. The computer-readable medium of claim 55, further comprising instructions configured to cause the computing device to:
notify an operator if an identified biological target meets the minimum score associated with the determined animal type.

58. The computer-readable medium of claim 55, wherein the minimum score is adjustable by an operator based on user input.

59. The computer-readable medium of claim 50, further comprising instructions configured to cause the computing device to:
determine an estimated age of the biological target.

60. The computer-readable medium of claim 59, further comprising instructions configured to cause the computing device to:
determine an age of the biological target based on one or more of:
a measured spine sway of the biological target;
a measured belly sag of the biological target;
a measured circumference of a neck of the biological target;
analysis of facial features of the biological target;
analysis of a gait of the biological target; and
identified signs of sexual dimorphism of the biological target.

61. The computer-readable medium of claim 50, further comprising instructions configured to cause the computing device to:
identify the biological target as a specific animal by fingerprinting the biological target.

62. The computer-readable medium of claim 61, further comprising instructions configured to cause the computing device to:
notify an operator if the biological target is identified as a specific animal previously flagged by a user.

63. The computer-readable medium of claim 50, further comprising instructions configured to cause the computing device to:
output the characteristics of the biological target via at least one display.

64. The computer-readable medium of claim 55, further comprising instructions configured to cause the computing device to:
use one or more displays to enable an operator to view an image of the biological target; and
cause the characteristics of the biological target to be output augmenting the image of the biological target.

65. The computer-readable medium of claim 55, further comprising instructions configured to cause the computing device to:
cause the characteristics of the biological target to be output via a wireless communication network.

66. The computer-readable medium of claim 50, wherein the reference comprises at least one threshold associated with one or more of:
a main beam length of an antler;
an inside spread of the antler;
a circumference measurement; and
a length of antler points.

67. The computer-readable medium of claim 50, further comprising instructions configured to cause the computing device to:
use a machine learning model configured to compare the captured data to the reference, wherein the reference comprises training data that includes images of previously characterized biological targets.

68. The computer-readable medium of claim 66, further comprising instructions configured to cause the computing device to:
use a first machine learning model configured to identify the biological target in the field of view of the one or more sensors; and
use a second machine learning model configured to determine characteristics of the biological target based on the comparison.

69. The computer-readable medium of claim 68, further comprising instructions configured to cause the computing device to:
use a further machine learning model configured to estimate an age of the biological target.

70. The computer-readable medium of claim 68, further comprising instructions configured to cause the computing device to:
use a further machine learning module configured to determine characteristics of an environment associated with a biological target selected from the group consisting of:
wind speed;
wind direction;
wind temperature;
weather conditions; and
characteristics of terrain.

71. The computer-readable medium of claim 68, further comprising instructions configured to cause the computing device to:
use a further machine learning module configured to determine one or more of:
a distance between the biological target and the device;
a geographical location of the biological target;
a relative elevation of the biological target; and
an absolute elevation of the biological target.

72. The computer-readable medium of claim 50, further comprising instructions configured to cause the computing device to:
determine one or more characteristics of an environment associated with an area; and
provide a user with one or more optimal locations to harvest the biological target based on the one or more environment characteristics.

73. The computer-readable medium of claim 50, further comprising instructions configured to cause the computing device to:
analyze image data to determine a distance to a biological target based on one or more of:
a size of the biological target relative to an object in the field of view with a known dimension;
a position of a parallax adjustment mechanism when an object is in focus; and
comparison of image data from at least two image sensors separated by a distance.
